(19) United States
(12) Patent Application Publication
(10) Pub. No.: US 2012/0045174 A1
(43) Pub. Date: Feb. 23, 2012

(54) LIGHT GUIDE

(75) Inventor: Manabu KOJIMA, Tokyo (JP)

(73) Assignee: YOKOGAWA ELECTRIC CORPORATION, Tokyo (JP)

(21) Appl. No.: 13/213,712

(22) Filed: Aug. 19, 2011

(30) Foreign Application Priority Data
Aug. 20, 2010 (JP) 2010-185027

(51) Int. Cl. G02B 6/26

(52) U.S. Cl. 385/38

(57) ABSTRACT

A light guide may include a light stop part that is formed at a first end of an optical fiber, the light stop part stopping a light that is incident at a second end of the optical fiber and is transmitted through the optical fiber, and a slit part that is formed in the light stop part, the slit part being configured to pass the light that is incident at the second end of the optical fiber and is transmitted through the optical fiber.

Priority is claimed on Japanese Patent Application No. 2010-185027, filed Aug. 20, 2010, the content of which is incorporated herein by reference.

### BACKGROUND OF THE INVENTION

1. Field of the Invention

The present invention relates to a light guide inputting light, for example, to a spectroscope. Specifically, the present invention, relates to a light guide capable of efficiently guiding spatial light to a spectroscope and performing high resolution measurement.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In general, resolution of a spectroscope is determined by an input slit width and an output slit width. In order to obtain high resolution, it is necessary to decrease the input slit width and the output slit width. Further, if the input slit width is not set to be narrower than the output slit width, desired resolution is not obtained.

That is, measurement resolution is limited due to a size of the input slit width. If the input slit width is set to be narrow, high resolution measurement may be anticipated. However, a light amount captured in the spectroscope is reduced and S/N is degraded in measurement. It is necessary to appropriately determine the input slit width based on resolution and S/N required for measurement.

FIG. 4 is a configuration diagram showing an example of a light guide for inputting light to a spectroscope, which is not illustrated in the figure, in accordance with the related art. This light guide uses a bundle optical fiber 1. The bundle optical fiber is a light cable that is a bundle of a plurality of optical fibers. The use of the bundle optical fiber facilitates handling such that a measured object can be easily captured in the spectroscope.

One end of the bundle optical fiber 1 is inserted into a first joint 2 and the other end is inserted into a second joint 3. Both ends of the bundle optical fiber 1 are fixed to the respective joints 2 and 3, for example, by an adhesive 4 or a hermetic seal.

An end of the first joint 2 opposite to the end connected to the bundle optical fiber 1 is defined as an end A. An end of the second joint 3 opposite to the end connected to the bundle optical fiber 1 is defined as an end B.

When the light guide is used for the spectroscope, the end A of the first joint 2 is connected to an input of the spectroscope. The end B of the second joint 3 is an input port for capturing spatial light. FIG. 5 is an enlarged view of the end A. The end A has a slit shape 5 having a length Y. The optical fibers are arranged on a line one by one to form the slit shape 5. FIG. 6 is an enlarged view of the end B.

According to this method, since a plurality of optical fibers are used, an area of a core is equal to several times the number of fibers in the bundle, allowing more light to be captured.

Further, since the end A connected to the spectroscope has a slit shape, a slit width X is equal to a core diameter of one fiber, realizing high resolution measurement.

Here, the slit shape 5 of the end A needs to match an output slit shape of the spectroscope. Specifically, it is efficient for a value of the height Y of the slit shape 5 to be equal to a length in a height direction of the output slit of the spectroscope.

Japanese Unexamined Patent Application, First Publication No, H09-184808 discloses a bundle optical fiber 1 that performs a light transmission.

Japanese Unexamined Patent Application, First Publication No. H04-278428 and Japanese Unexamined Patent Application, First Publication No. H06-201917 also discloses a technology that uses an optical fiber as a light guide.

A light amount captured by the bundle optical fiber is determined by the core area of the used optical fiber and the number of optical fibers in the bundle. A core area of the entire bundle optical fiber is proportional to the captured light amount. As described above, it is efficient for the value of the height Y of the slit shape 5 of the bundle optical fiber to be equal to the length in a height direction of the output slit of the spectroscope.

In general, the length in the height direction of the output slit is in the order of a few mm. From this, the number of optical fibers in the bundle is necessarily determined.

Further, in general, a fiber having a fiber outer diameter not greater than a fiber core diameter, i.e., a fiber having a high core occupancy rate, is used for the bundle optical fiber. However, most optical fibers have a fiber core diameter of 100μ or more.

However, it is necessary to further decrease “incident slit width”=“core diameter of optical fiber” in order to increase the resolution of the spectroscope. Specifically, an incident slit of about 20 μm is required.

However, if a core diameter of the optical fiber is 50 μm or less, a fiber having a high core occupancy rate is scarcely available. Specifically, when the core diameter is 20 μm, an outer diameter of a typical fiber is 125 μm.

For example, when a line array having a slit height of 1 mm is formed using such optical fibers, only eight optical fibers can be arranged. That is, only a light amount corresponding to 20 μm×8 fibers can be captured with the slit height of 1 mm.

That is, with a conventional light guide, it is not possible to efficiently capture light even when the bundle optical fiber is configured of optical fibers having a small core diameter in order to increase the resolution of the spectroscope.

### SUMMARY

The present invention provides a light guide capable of both increasing resolution of a spectroscope and efficiently capturing light.

A light guide may include a light stop part that is formed at a first end of an optical fiber, the light stop part stopping a light that is incident at a second end of the optical fiber and is transmitted through the optical fiber, and a slit part that is formed in the light stop part, the slit part being configured to pass the light that is incident at the second end of the optical fiber and is transmitted through the optical fiber.

The light stop part may be a light stop film that is formed by covering the first end of the optical fiber.

The light stop part may be a cap with a slit that is formed by covering the first end of the optical fiber.

A core diameter of the optical fiber may be more than or equal to 150 μm.

A slit width of the slit part may be approximately 20 μm.

The slit part may have a shape of a line that passes through a center of the light stop part.

A light guide may include an optical fiber, and a first joint that is connected to a first end of the optical fiber, the first joint being fixed to the optical fiber so that the first end of the optical fiber has a flat surface. The first joint may include a light stop part that stops a light that is incident at a second end of the optical fiber and is transmitted through the optical fiber, and a slit part that is formed in the light stop part, the slit part being configured to pass the light that is incident at the second end of the optical fiber and is transmitted through the optical fiber.

The light guide may further include a second joint that is connected to the second end of the optical fiber, the second joint being fixed to the optical fiber so that the second end of the optical fiber has a flat surface.

The light stop part may be a light stop film that is formed by covering the first end of the optical fiber.

The light stop part may be a cap with a slit that is formed by covering the first end of the optical fiber.

A core diameter of the optical fiber may be more than or equal to 150 μm.

A slit width of the slit part may be approximately 20 μm.

The slit part may have a shape of a line that passes through a center of the light stop part.

A light guide method may include transmitting a light through the optical fiber, the light being incident at a first end of an optical fiber, stopping the light, which has been transmitted through the optical fiber, at a light stop part that is formed at a second end of the optical fiber, and passing the light, which has been transmitted through the optical fiber, through a slit part that is formed in the light stop part.

The light guide method may further include outputting the light, which has passed through the slit part, to a spectroscope.

The light stop part may be a light stop film that is formed by covering a first end of the optical fiber.

The light stop part may be a cap with a slit that is formed by covering a first end of the optical fiber.

A core diameter of the optical fiber may be more than or equal to 150 μm.

A slit width of the slit part may be approximately 20 μm.

The slit part may have a shape of a line that passes through a center of the light stop part.

In the present invention, a light blocking member for blocking light is formed at one end of an optical fiber, for example, having a core diameter of 150 μm or more. A slit for passing light propagated via the optical fiber and input from the other end is formed in the light blocking member. A slit width is small in the order of 20 μm. Accordingly, it is possible to efficiently capture light. It is possible to realize a light guide capable of measurement with high resolution and high S/N, for example, when the light guide is connected to a spectroscope.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a view illustrating an example of a configuration of a light guide in accordance with a first preferred embodiment of the present invention;

FIG. 2 is an enlarged view seen from an end A of the light guide of FIG. 1;

FIG. 3 is an enlarged view seen from an end B of the light guide of FIG. 1;

FIG. 4 is a view illustrating an example of a configuration of a light guide in accordance with the related art;

FIG. 5 is an enlarged view seen from an end A of the light guide of FIG. 4; and

FIG. 6 is an enlarged view seen from an end B of the light guide of FIG. 4.

### DETAILED DESCRIPTION OF THE PREFERRED EMBODIMENTS

The present invention will be now described herein with reference to illustrative embodiments. Those skilled in the art will recognize that many alternative embodiments can be accomplished using the teaching of the present invention and that the present invention is not limited to the embodiments illustrated herein for explanatory purposes.

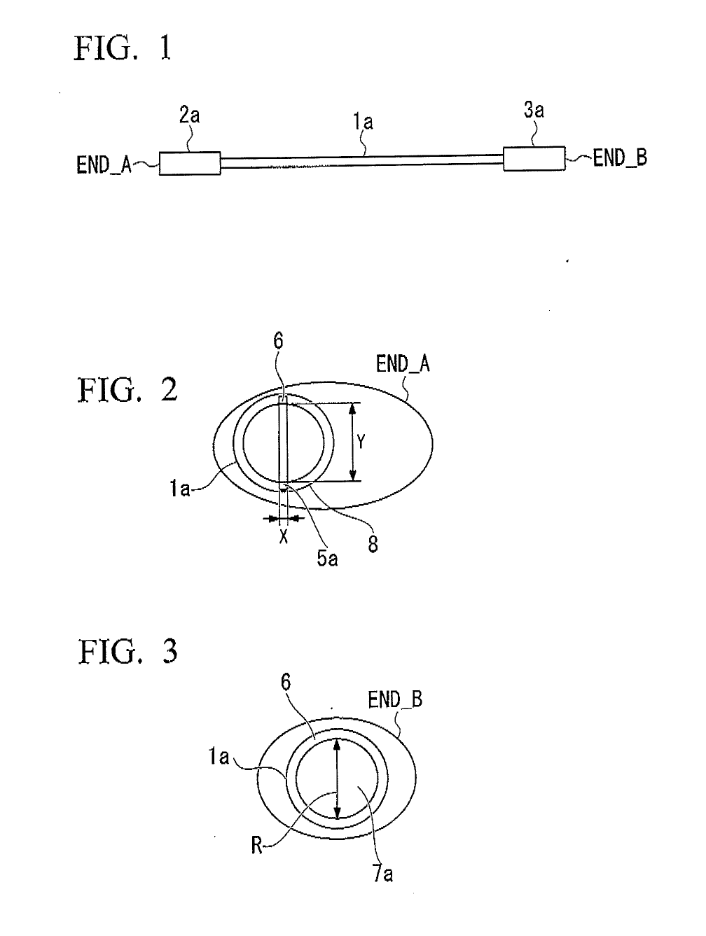

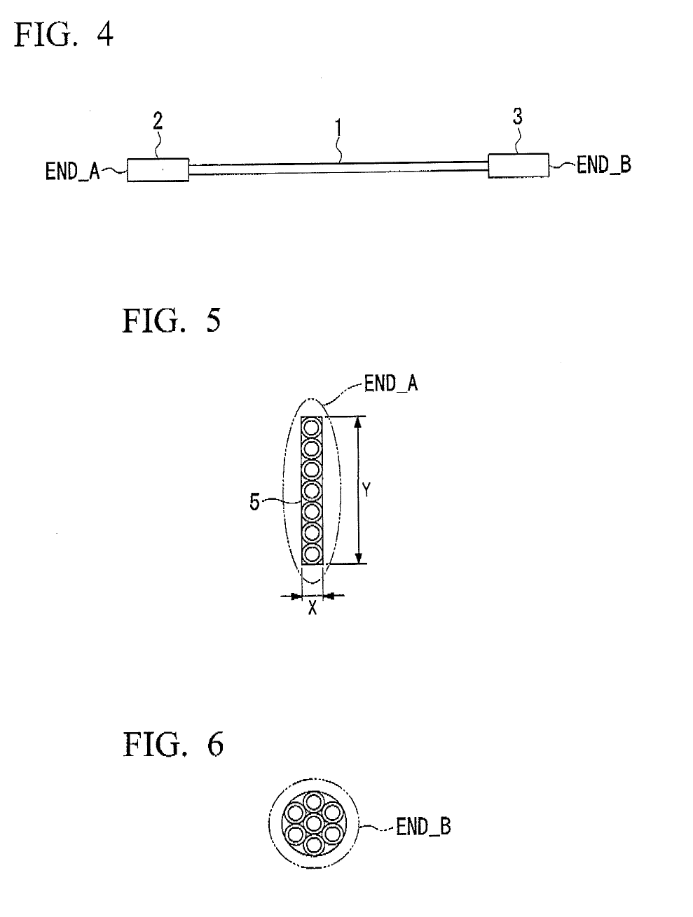

FIG. 1 is a view illustrating an example of a configuration of a light guide in accordance with a first preferred embodiment of the present invention. The light guide in accordance with the first preferred embodiment of the present invention includes an optical fiber 1a that has a large caliber is used. The bore of the core of the optical fiber 1a may be larger than or equal to 150 μm. One end of the optical fiber 1a is interposed into and connected to a first joint 2a. Another end of the optical fiber 1a is interposed into and connected to a second joint 3a.

An end A of the first joint 2a is the opposite side connected to the optical fiber 1a. An end B of the second joint 3a is the opposite side connected to the optical fiber 1a.

When light is input to a spectroscope, the end A of the first joint 2a is connected to an input gate of the spectroscope. The end B of the second joint 3a is an input gate for spatial light.

FIG. 2 is a magnified view seen from the end A. A light stop film 8 is formed at the end A by using a light stop material. A slit FIG. 5a is formed in the light stop film 8. The width of the slit FIG. 5a is X, and the length of the slit FIG. 5a is Y. The slit width X is about 20 μm, for example.

FIG. 3 is a magnified view seen from the end B. The amount of received light depends on the magnitude of a core diameter R. The core diameter R is more than or equal to 150 μm, for example.

By the above-described configuration, the input slit width of the spectroscope can be lessened and the resolution performance of the spectroscope can be improved. Also, the core diameter R of the optical fiber 1a is large, the amount of light input into the spectroscope is increased, and the S/N ratio at the measurement time is improved.

The light stop film 8 may be formed only at the end part of the optical fiber 1a. The light stop film 8 may be formed whole of the end A of the first joint 2a. The slit FIG. 5a may be formed at the same time as the light stop film 8 is formed. The slit FIG. 5a may be formed by etching and the like that uses a semiconductor technology after the light stop film 8 is formed.

A transparent cap may be capped on the end part of the optical fiber. Then, the slit figure may be formed on the transparent part of the transparent cap by forming the light stop film. Then, the transparent cap with slit may be capped on the first joint 2a for the light stop member.

As used herein, the following directional terms “forward, rearward, above, downward, right, left, vertical, horizontal, below, and transverse” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” “nearly”, and “approximately” as used herein mean a reasonable amount of deviation of the modified term such that the end result is not significantly changed. For example, these terms can be construed as including a deviation of at least ±5 percents of the modified term if this deviation would not negate the meaning of the word it modifies.

The term “unit” is used to describe a component, section or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A light guide comprising:
a light stop part that is formed at a first end of an optical fiber, the light stop part stopping a light that is incident at a second end of the optical fiber and is transmitted through the optical fiber; and
a slit part that is formed in the light stop part, the slit part being configured to pass the light that is incident at the second end of the optical fiber and is transmitted through the optical fiber.

2. The light guide according to claim 1, wherein the light stop part is a light stop film that is formed by covering the first end of the optical fiber.

3. The light guide according to claim 1, wherein the light stop part is a cap with a slit that is formed by covering the first end of the optical fiber.

4. The light guide according to claim 1, wherein a core diameter of the optical fiber is more than or equal to 150 μm.

5. The light guide according to claim 4, wherein a slit width of the slit part is approximately 20 μm.

6. The light guide according to claim 1, wherein the slit part has a shape of a line that passes through a center of the light stop part.

7. A light guide comprising:
an optical fiber; and
a first joint that is connected to a first end of the optical fiber, the first joint being fixed to the optical fiber so that the first end of the optical fiber has a flat surface, the first joint comprising:
a light stop part that stops a light that is incident at a second end of the optical fiber and is transmitted through the optical fiber; and
a slit part that is formed in the light stop part, the slit part being configured to pass the light that is incident at the second end of the optical fiber and is transmitted through the optical fiber.

8. The light guide according to claim 7, further comprising:
a second joint that is connected to the second end of the optical fiber, the second joint being fixed to the optical fiber so that the second end of the optical fiber has a flat surface.

9. The light guide according to claim 7, wherein the light stop part is a light stop film that is formed by covering the first end of the optical fiber.

10. The light guide according to claim 7, wherein the light stop part is a cap with a slit that is formed by covering the first end of the optical fiber.

11. The light guide according to claim 7, wherein a core diameter of the optical fiber is more than or equal to 150 μm.

12. The light guide according to claim 11, wherein a slit width of the slit part is approximately 20 μm.

13. The light guide according to claim 1, wherein the slit part has a shape of a line that passes through a center of the light stop part.

14. A light guide method comprising:
transmitting a light through the optical fiber, the light being incident at a first end of an optical fiber;
stopping the light, which has been transmitted through the optical fiber, at a light stop part that is formed at a second end of the optical fiber; and
passing the light, which has been transmitted through the optical fiber, through a slit part that is formed in the light stop part.

15. The light guide method according to claim 14, further comprising:
outputting the light, which has passed through the slit part, to a spectroscope.

16. The light guide method according to claim 14, wherein the light stop part is a light stop film that is formed by covering a first end of the optical fiber.

17. The light guide method according to claim 14, wherein the light stop part is a cap with a slit that is formed by covering a first end of the optical fiber.

18. The light guide method according to claim 14, wherein a core diameter of the optical fiber is more than or equal to 150 μm.

19. The light guide method according to claim 18, wherein a slit width of the slit part is approximately 20 μm.

20. The light guide method according to claim 14, wherein the slit part has a shape of a line that passes through a center of the light stop part.
